(19) United States
(12) Patent Application Publication
(10) Pub. No.: US 2017/0350570 A1
(43) Pub. Date: Dec. 7, 2017

(54) ILLUMINATION APPARATUS WITH SENSOR AT THE ABSORBER

(71) Applicant: OSRAM GmbH, Munich (DE)

(72) Inventors: Stephan Schwaiger, Ulm (DE); Ricarda Schoemer, Zusmarshausen (DE); Juergen Hager, Herbrechtingen (DE); Oliver Hering, Niederstotzingen (DE)

(21) Appl. No.: 15/603,550

(22) Filed: May 24, 2017

(30) Foreign Application Priority Data
Jun. 2, 2016 (DE) 102016209648.6

(51) Int. Cl. F21S 8/10; B60Q 1/04

(52) U.S. Cl. CPC F21S 48/1757; B60Q 1/04

(57) ABSTRACT

An illumination apparatus is provided. The illumination apparatus includes a light-emitting device including one or more light sources, a mirror device including at least one pivotable mirror for directing light from the one or more light sources in a defined first pivot state into a first solid angle region in which the light is utilized in accordance with operation, and a defined second pivot state into a second solid angle range that differs from the first one and in which the light is directed onto an absorber device of the illumination apparatus. The absorber device includes a sensor with which a function of the illumination apparatus may be checked.

### CROSS-REFERENCE TO RELATED APPLICATION

This application claims priority to German Patent Application Serial No. 10 2016 209 648.6, which was filed Jun. 2, 2016, and is incorporated herein by reference in its entirety.

### TECHNICAL FIELD

Various embodiments relate generally to an illumination apparatus having a light-emitting device including one or more light sources and a mirror device including a pivotable mirror or micromirror array for directing light from the one or more light sources. The mirror can adopt the following pivot states: a defined first pivot state for directing the light into a first solid angle region in which the light is utilized in accordance with operation, a defined second pivot state for directing the light into a second solid angle region that differs from the first one and in which the light is directed onto an absorber device of the illumination apparatus, and a third pivot state for directing the light into a third solid angle region located between the first and second solid angle regions, wherein the third pivot state is always adopted when the mirror device is in an unpowered state. Moreover, various embodiments relate to a method for checking a function of such an illumination apparatus.

### BACKGROUND

“Innovative” headlight systems are nowadays implemented more and more in vehicles. This relates e.g. to laser-based systems and matrix systems. Both are afflicted with certain weaknesses.

In laser-based systems, laser light is converted into visible light using a converter. Laser systems must be “laser safe,” i.e. the light sources should ideally be inherently safe. Alternatively, a laser system should be made safe using a sensor system such that, in the event of a fault (in the normal case, no dangerous laser radiation should emerge either), it is possible to switch off quickly without anyone being harmed. In this case, the sensor system would have to cover the complete angle region of the emitted light (or of the potential emission of light) to ensure that laser radiation cannot emerge anywhere. However, in current systems, this is technically not feasible and is thus also not implemented.

Matrix systems typically have a plurality of “pixels” (actually in the implementations to date at most only columns). In order to ensure a homogeneous and acceptable light distribution, such systems, if they consist of a plurality of sub-systems, which is typically the case, must be adjusted with respect to one another. This adjustment, however, is dependent on many parameters (e.g. ambient temperature), such that it can deteriorate or change during operation. For example in high-resolution systems that use a multiplicity (>20) of columns or rows with light-emitting pixels, this adjustment is critical and complicated. However, there is a desire for these systems to become better and better, i.e. for systems with increasingly high resolution.

A conventional DMD illumination system (digital micromirror device) has a multiplicity of light sources. Each of the light sources direct light onto the DMD system and specifically onto a corresponding position of a matrix of micromirrors. Each light source is positioned such that the light that is reflected by the matrix consisting of micromirrors is projected out of the system. A control circuit is coupled to the multiple light sources and the DMD system such that it can control the position of the matrix of micromirrors and moreover can provide control signals for switching each of the multiple light sources on and off. Each of the mirrors of the DMD system can adopt two defined pivot positions. In a first pivot position (typical operating state), the light is directed to the outside via a secondary optical unit (on-state). In a second pivot position that is likewise defined, the mirror directs light from the light source onto an absorber (off-position). The mirror adopts an intermediate position between the first pivot position and the second pivot position if the mirror or its mechanical system is not driven or no current is supplied to it.

### SUMMARY

An illumination apparatus is provided. The illumination apparatus includes a light-emitting device including one or more light sources, a mirror device including at least one pivotable mirror for directing light from the one or more light sources in a defined first pivot state into a first solid angle region in which the light is utilized in accordance with operation, and a defined second pivot state into a second solid angle range that differs from the first one and in which the light is directed onto an absorber device of the illumination apparatus. The absorber device includes a sensor with which a function of the illumination apparatus may be checked.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a schematic view of an illumination apparatus according to various embodiments with different states; and

FIG. 2 shows a schematic flowchart of a method according to various embodiments.

### DESCRIPTION

The following detailed description refers to the accompanying drawings that show, by way of illustration, specific details and embodiments in which the invention may be practiced.

The exemplary embodiments explained in more detail below represent preferred embodiments of the present invention. It should be noted that the individual features can be implemented not only in the combinations of features listed here, but also alone or in other technically feasible combinations.

An illumination apparatus, as will be described below, can be used, for example, in a motor vehicle headlight for a low-beam function, a high-beam function or any desired signaling, effect or entertainment light function. In various embodiments, an illumination apparatus of this type can also be used as a projector for home and cinema applications or the like.

Various embodiments provide an illumination apparatus in which the function can be checked reliably. Moreover, a corresponding method for checking a function of such an illumination apparatus is intended to be specified.

Developments of various embodiments can be gathered from the dependent claims.

According to various embodiments, an illumination apparatus having a light-emitting device including one or more light sources is thus provided. These light sources can be, for example, a light-emitting diode source or a laser light source. In a laser light source, the laser light is typically converted into e.g. white light using a converter.

The illumination apparatus can be used, for example, for room or facility illumination and for home and cinema projectors. In a further application, the illumination apparatus is used for car headlights. Here, they cannot only perform low beam and high beam functions, but also other light functions such as for example for signaling or even effect and entertainment light functions.

The illumination apparatus additionally has a mirror device including a pivotable mirror for directing light from the one or more light sources. The mirror device can, of course, also have a plurality of such mirrors (e.g. a micromirror array). The mirror or mirrors direct the light in a defined first pivot state into a first solid angle region in which the light is utilized in accordance with operation, in a defined second pivot state into a solid angle region that differs from the first one and in which the light is directed onto an absorber device of the illumination device, and in a third pivot state optionally into a third solid angle region located between the first and second solid angle regions, wherein the third pivot state is always adopted when the mirror device is in an unpowered state. That means that the mirror in the first pivot state is in an on-state, in which it directs the light to the outside in the desired fashion so that it may be utilized. In contrast, the mirror in the second pivot state is in an off-state, in which the light is not directed to the outside for illumination purposes. Rather, it is absorbed in the second pivot state in an absorber of the absorber device. It is thus possible, for example in the case of a fault of the light-emitting device or if this is the intention, for the light to be kept in the illumination apparatus, for example without doing harm.

If the mirror device consists of a large number of mirrors, it is possible to generate a high-resolution light distribution by bringing each individual mirror selectively into the on- or off-state. If the individual mirrors are operated with very high switching frequencies of up to several thousand status changes per second, it is also possible to generate gray levels in white light sources, and also colored high-resolution images in color light sources (in combination with color wheels or shutters).

The third pivot state of the mirror does not have to be a defined pivot state. Rather, it can be a pivot state that is adopted by the mirror if corresponding actuators of the mirror device are without power. This third pivot state, for example, can be maintained within a specific tolerance range by way of a mechanical spring. This third pivot state may be achieved for example by a latching state or in the case of the greatest possible mechanical relaxation of a spring.

The absorber device advantageously has a sensor with which a function of the illumination apparatus may be checked. In various embodiments, the sensor can be configured to detect the intensity of light possibly even in dependence on the wavelength. In this way, the light that is incident on the absorber device or the absorber thereof can be analyzed. For example, if the converter of a laser light source is defective and too high a proportion of non-converted light strikes the absorber device or the sensor that is integrated therein, this can be taken as a trigger for switching the light source off or for reducing the output thereof. The signal of the sensor, however, can also be used for other open-loop and closed-loop control purposes and for storing and representing corresponding information.

The sensor can be implemented as a sensor array that is segmented or pixelated such that various functions can also be measured at the same time. In one variant, the sensor array is mounted on a rotating wheel which rotates through the OFF radiation, and on which sensor elements for various measurement functions are arranged tangentially and/or on neighboring tracks. A measurement function (static or dynamic in the case of the revolving wheel) could also be performed by way of a circumferential phosphor strip with a detection sensor that measures the phosphor (yellow) conversion or an excess thereof caused by the (faulty) laser light.

The mirror device has a micromirror arrangement having a large number of mirrors of the stated type. The mirror device can thus contain a DMD, mentioned earlier. Such a DMD can have, for example, from 20 to several million mirrors. It is thus possible by way of the illumination apparatus to implement a correspondingly high number of pixels. If appropriate, the mirror device is a mirror device of correspondingly high resolution.

The light-emitting device can have a plurality of light sources, and the plurality of light sources can be controlled individually or in groups by open-loop control, closed-loop control, or may be calibrated in dependence on a signal of the sensor. For example, the function of each light source can be influenced individually in dependence on a signal of the sensor. For example, the function of the individual light sources or groups thereof can be checked one after another by switching on the individual light sources separately from one another or in groups and observing the respective sensor signal.

Each of the plurality of light sources can be controllable by a control device of the illumination apparatus with in each case individual modulation. An analysis device of the illumination apparatus can be designed to obtain, from the signal of the sensor, information relating to a function of each individual one of the plurality of light sources or a group of the plurality of light sources in particular for the control device. Checking thereof can be carried out at the same time on account of the different modulation of the individual light sources or groups. To this end, the sensor signal should be analyzed with respect to the respective modulations. If, for example, in a specific modulation a blue component is measured that is too high, this could indicate that a converter of the light source with this modulation is defective and converts too little blue light into yellow light.

According to an development, each mirror in the mirror device is controllable individually into the second pivot state. That means that each mirror can be placed into the off-state independently of the other mirrors by directing the light onto the absorber device. For example, one of a plurality of mirrors can be used to guide light onto the absorber device or the sensor that is integrated therein in order to be able to check the respective light source or light sources. If for example a mirror at the edge of the matrix is not used for illumination purposes, it can be used for checking the function of the illumination apparatus.

In an embodiment, one or more of the mirrors for checking the function of the illumination apparatus are movable into the second pivot state cyclically or according to a specified pattern. This can be done for example by the mirror or mirrors periodically directing the light into the absorber device, which can also be set up as a sensor device, such that the function of the illumination apparatus can be continuously checked. For example, it is thus possible for the required laser safety to be constantly observed during the operation of the illumination apparatus for example. The absorber device can in this case be segmented or pixelated, with the result that various measurements can be sequentially carried out (color, intensity, timing of the laser sources, polarization degree of the radiation, decay behavior of the fluorescence etc.).

In one embodiment, a plurality of mirrors of the micromirror arrangement can form a pattern, and the mirror device can be configured such that all the mirrors of the pattern are controllable into the second pivot state at the same time independently of the remaining mirrors of the micromirror arrangement. In other words, for checking the function, it is possible to move in each case a large number of mirrors that together form a specified pattern into the second pivot state, i.e. the off-state. For example, all four corner mirrors of a rectangular micromirror arrangement can be switched into the second pivot state at the same time. Alternatively, all or some of the mirrors in a motor vehicle during low-beam operation can be pivoted, for example, into the second pivot state for the high-beam function, with the result that they can be used to check the function of the one or the plurality of light sources. The patterns can be used to check not only the function of the light sources, but also the function of the mirror device or of the individual mirrors. If, for example, the individual mirrors are pivoted into the off-state one after the other, this may under certain circumstances not impair the desired illumination function. Nevertheless, it is possible in this way to check all the mirrors one after another with respect to their function. The patterns here have the effect that not all mirrors need to be checked individually.

If appropriate, the sensor may be used to capture an optical output, a color point of the light or a wavelength distribution. In various embodiments, the light source itself can be checked by way of the optical output. A converter of the light-emitting device, for example, is more suited for being checked by way of the color point of the light and the wavelength distribution. If, for example, the converter is damaged due to overheating, or it operates above its own output limits due to excessive output of the laser, the conversion rate and thus generally also the wavelength distribution of the light leaving the converter changes. This manifests in a spectral displacement and thus a change in the color point.

In a further embodiment, one or more of the mirrors are controllable into the second pivot state “permanently” (i.e. for a specifiable period or up to a specifiable event) or in specific intervals by the mirror device in dependence on a signal of the sensor. That means that one or more pixels can be switched off for prolonged periods. This may be necessary if, for example, the phosphor plate has local defects or the relevant mirror or mirrors are damaged. If, for example, the light source or a major part of the converter is damaged, either the light source should be switched off or all the mirrors should be switched into the off-state. Alternatively, it is possible to switch into a selectable intermittent operation during which the on/off ratio of a micromirror may be set as 1:10, 1:1000, 1:10,000, 1:100,000, 1:1,000,000. As a result, a certain level of basic function is maintained, but the potential for danger is significantly reduced due to the intermittent operation (and can be used e.g. for emergency light functions).

Various embodiments provide a method for checking a function of an illumination apparatus having one or more light sources, a mirror device including a pivotable mirror for directing light of the one or more light sources in a defined first pivot state into a first solid angle region in which the light is utilized in accordance with operation, a defined second pivot state into a second solid angle range that differs from the first one and in which the light is directed onto an absorber device of the illumination apparatus, and optionally a third pivot state into a third solid angle region between the first and second solid angle regions, wherein the third pivot state is always adopted if the mirror device is in an unpowered state, wherein the absorber device has a sensor with which the function of the illumination apparatus is checked in the second pivot state of the mirror.

The above-mentioned developments of the illumination apparatus can also be used for the method according to various embodiments. Here, the same possible variations and effects apply.

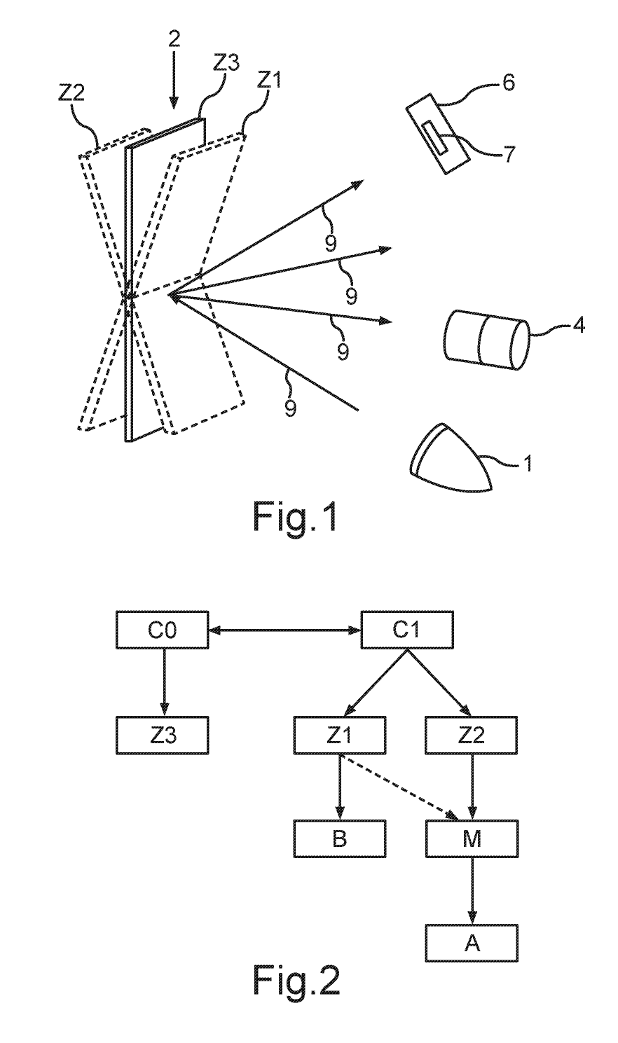

The example of an illumination apparatus according to various embodiments illustrated in FIG. 1 has a light-emitting device 1. Such a light-emitting device 1 can include one or more light sources. A laser system, a light-emitting diode system or the like can serve as the light source, for example. The one or more light sources of the light-emitting device 1 are controlled or operated by a control device (not illustrated in FIG. 1).

The illumination apparatus furthermore has a mirror device having one or more mirrors 2. Each mirror 2 is driven in each case by an actuator (not illustrated) such that it can perform a pivot movement about its central axis parallel to its mirror surface. The actuator or actuators are in turn driven by a control device which can be configured separately or embodied as one unit together with the control device of the light-emitting device. Moved by an actuator, the mirror 2 can adopt a defined first state Z1. In this state, the light from the light-emitting device is directed onto an optional secondary optical unit 4. Here, the light is optically prepared for the respective use, e.g. focused.

The mirror 2 can adopt a defined second pivot state Z2. In this pivot state, the mirror 2 directs the light from the light-emitting device 1 onto an absorber device 6. The light produced by the light-emitting device 1 is absorbed by this absorber device 6, i.e. is destroyed. In the second pivot state of the mirror 2, no light should thus emerge from the illumination apparatus.

In addition to the actual absorber, the absorber device 6 also has a sensor 7. This sensor 7, which may be segmented or pixelated, captures at least some of the light that is directed onto the absorber device 6 by the mirror 2 in the second pivot state Z2. A corresponding sensor signal is evaluated and can provide information relating to the function of the illumination apparatus and in particular relating to the function of the light-emitting device 1 and/or of the mirror device having the mirror 2.

The mirror 2 can adopt a third state Z3, for example if no power is supplied to its actuator or the control device of the mirror device. This third pivot state can be the pivot state that the mirror 2 adopts for example due to a spring that is installed accordingly. While the third pivot state Z3 represents for example an intermediate or central position of the mirror 2, the first pivot state Z1 and the second pivot state Z2 represent for example respective extreme positions with respect to the pivotability of the mirror 2. For example, with a specified polarity, an electromagnet drags the mirror 2, all the way to the stop position into the first pivot state Z1. In the case of a polarity reversal, the electromagnet pushes or drags the mirror 2 to the stop position into the second pivot state Z2. The third pivot state Z3 is more or less undefined and is between the two other defined pivot states Z1 and Z2. If appropriate, it is mechanically defined by way of a spring or latching.

In connection with FIG. 2, an example of a method according to various embodiments will now be indicated. To this end, e.g. an illumination apparatus according to FIG. 1 is used. It is assumed that the light-emitting device 1 is illuminated. If the mirror 2 is not actuated in an off-state C0, it is in the third pivot state Z3 or is mechanically moved into it.

If the control device of the mirror is switched on and thus moves from the off-state C0 into the on-state C1, the mirror is preferably electrically actuated. Depending on the desired position, it adopts the first pivot state Z1 or the second pivot state Z2. In the first pivot state Z1, the illumination apparatus performs an illumination function B. On the other hand, if the mirror is controlled into the second defined pivot state Z2, the illumination apparatus performs a measurement function M. The sensor 7 here captures the light that is incident on the absorber device 6. However, this does not preclude the sensor 7 from also capturing light radiation (fault light) even in the first pivot state Z1 and thus likewise the illumination apparatus from performing the measurement function M (compare dashed arrows). The measurement function M is coupled to an evaluation function A. What is evaluated here is whether the captured light, for example in terms of intensity, wavelength and the like, corresponds to the specifications for the illumination apparatus. If not, a corresponding error message can be output. With the resulting evaluation signal it is also possible for the control of the light-emitting device or the mirror device to be influenced. In various embodiments, it is thus possible to implement open-loop or closed-loop control of these components.

More concrete applications will be illustrated below in more detailed examples. For example, a DLP-based system (digital light processing), which generally has a DMD (digital micromirror device), will be proposed. This DLP system can have a (surface) sensor, which is, if appropriate, segmented or pixelated, in what is known as the “beam dump,” i.e. in or at the absorber. The light from the light-emitting device 1 strikes a mirror array (DMD), which consists of many small mirrors (possibly several million), which can be individually actuated and folded. The mirror 2 of FIG. 1 represents, for example, one of these mirrors.

The individual mirrors are either set such that light can be further processed in the secondary optical unit 4 (“on state energy”), or is incident on the absorber or the absorber device 6 (“off state energy”) and is no longer actively used. To this end, the respective mirrors of the DMD adopt, in dependence on or independently of one another, the first pivot state Z1 or the second pivot state Z2. The third pivot state Z3 (“flat state”) cannot be actively actuated and is present in a more undefined manner (“floating”) in the switched-off state of the control device or of the mirror device.

Due to the large number of small mirrors or pixels, it is possible to produce a high-resolution image, because the light either uses every individual mirror or is or can be “destroyed” (i.e. dark with respect to the secondary optical unit 4, i.e. beam dump use). The small DMD mirrors can be operated for example at very high switching frequencies of up to several thousand status changes per second. In connection with an intelligent actuation, intermediate stages (gray tones) are thus also possible, or even any desired color information with colored light sources (possibly also with color wheels or shutters). In this way, it is possible to implement e.g. home and cinema projectors.

The light-emitting device 1 with which the DMD or the DLP mirrors are illuminated can be a complex module of one or more light sources, such as e.g. LARP, laser, LED etc., and include conversion elements, and a refined primary optical unit. The primary optical unit in turn can include e.g. a beam combiner for the various light sources and diverse optical elements for light shaping which project the light onto the DMD.

According to various embodiments, the absorber device has a sensor in addition to an actual absorber. This means that the sensor can be arranged in or at the absorber. This has numerous effects, as will be shown by the following considerations.

In what is known as a LARP arrangement (laser activated remote phosphor), laser light is converted at least partially via a converter into (harmless, since nearly incoherent) light and used directly for illumination purposes. A defect of this converter would lead to laser radiation. Since the entire light quantity that is used in the “on state” (first pivot state Z1) for the application is incident in the “off state” (second pivot state Z2) on the absorber device or the sensor 7, it can ensure “laser safety.”

In the case of detected unevenness or deviations, individual laser light sources or all laser light sources of the light-emitting device 1 can be switched off entirely or only in part. If the sensor 7 detects an unevenness in the illumination only in a partial region of the DMD, a partial switch-off of the affected pixels can take place, which results in a partial switch-off for only the affected regions of the light distribution for example in the far field of a motor vehicle headlight, since the secondary optical unit 4 carries out imaging of the DMD into the far field. It is also conceivable, for example, that a base light function may be realized with light sources that do not fall within the safety-technological subjects of LARP technology and can therefore always be used, if needed.

If the light distribution on the conversion element in a LARP arrangement is imaged directly onto the DMD, there is the possibility of deliberately setting one or more mirrors to “off,” i.e. pivot state Z2, and to thus examine a specific region e.g. of the converter for faults (targeted detection). This can always be the same micromirror (or a group of micromirrors, the patterns and form of which can be adapted to the application). If, for example, the converter can adopt only specific, known defect states, only the affected pixels should be examined. It may be provided that only the pixels or micromirrors are used for targeted detection that cannot be used or should not be used for the illumination function. Moreover, there is also the possibility of carrying out the detection in alternating fashion or in specific patterns or by way of running through all the mirrors.

The sensor 7 can measure, for example, the optical output, the wavelength distribution or the color point of the light, which, for example, falls in the cone of the “off state.” Next, a comparison between the measured and the expected value, which may be stored in the software, is carried out. If the deviation is too great, this can be assessed as being a fault on the conversion element, for example. In reaction thereto, there are various possibilities: either the affected pixels must be in the “off state” (second pivot state Z2 of the micromirrors) from there on and/or individual laser sources can be readjusted (e.g. dimming in case of roll-over on the conversion element) such that the measurement values in the sensor are back in the normal range. That means that the output of the laser is then reduced to the extent that the conversion element can convert the input radiation to the intended degree. As concerns the faults, a distinction should generally also be made as to whether all pixels that are illuminated by a light source show the same fault image. In that case, the cause is probably down to the light source. If only individual pixels show a deviation (e.g. in the peak of the light distribution), a local defect of the conversion plate is likely.

If the conversion element has a permanent defect, it may also be possible for individual laser light sources to be switched off, depending on the design of the primary optical unit, such that the faulty region of the conversion element is no longer exposed to light and the energy consumption is minimized. It is additionally possible for an error message, for example for the driver (e.g. flashing of a symbol on the dashboard) or the garage, to be output after a fault is detected on the conversion element.

The detected signal does not necessarily have to be used only for fault detection. Likewise possible is checking and/or calibrating of the (optical) output in different regions of the light distribution. If, for example, the intensity in the peripheral regions is intended to be exactly half the maximum in the center, the theoretically provided output can be practically measured and adjusted. In various embodiments, the output or intensity, i.e. for each individual pixel, can thus be set or controlled in open-loop or closed-loop fashion in dependence on the location.

Such calibration is of interest e.g. if a plurality of light sources contribute to the illumination, such as a plurality of LEDs (or laser sources or even hybrid systems consisting of LED and LARP). In this case, each light source by itself can, for example, be detected in each pixel and calibrated.

Calibration can be both relative and absolute. In the case of a relative calibration, for example different light sources are calibrated with respect to one another and/or individual pixels or mirrors are calibrated with respect to one another. In the case of absolute calibration, on the other hand, matching takes place for absolute calibration.

Calibration or detection can be performed both once (e.g. when switching on or switching to a specific light function) and repeatedly, periodically or continuously. In this way, it is also possible to readjust the system accordingly if the latter is exposed to a drift for example at higher temperatures or over its lifetime.

The duration and/or frequency (e.g. PWM) of such measurement or examination intervals can be identical or different for the individual mirrors and/or light sources. As a result, the mirrors or light sources can be differentiated.

Furthermore, filters (e.g. interchangeable ones) can be connected upstream of the sensor for example for increasing the sensitivity or the dynamic range. These filters may not just be gray filters that reduce the intensity in broadband fashion, but also color filters that partially reduce the spectrum.

### LIST OF REFERENCE SIGNS

1 light-emitting device

2 mirror

4 secondary optical unit

6 absorber device

7 sensor

9 rays

A evaluation function

B illumination function

C0 off-state

C1 on-state

M measurement function

Z1 first pivot state

Z2 second pivot state

Z3 third pivot state

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. An illumination apparatus, comprising:
a light-emitting device including one or more light sources,
a mirror device including at least one pivotable mirror for directing light from the one or more light sources in
a defined first pivot state into a first solid angle region in which the light is utilized in accordance with operation, and
a defined second pivot state into a second solid angle range that differs from the first one and in which the light is directed onto an absorber device of the illumination apparatus,
wherein the absorber device comprises a sensor with which a function of the illumination apparatus may be checked.

2. The illumination apparatus of claim 1,
wherein the mirror device has a micromirror arrangement having a multiplicity of mirrors of the type mentioned.

3. The illumination apparatus of claim 1,
wherein the light emitting device has a plurality of light sources, and the plurality of light sources can be controlled individually or in groups by open-loop control, closed-loop control, or may be calibrated in dependence on a signal of the sensor.

4. The illumination apparatus of claim 3,
wherein each of the plurality of light sources can be controllable by a control device of the illumination apparatus with in each case individual modulation, and an analysis device of the illumination apparatus is designed to obtain, from the signal of the sensor, information relating to a function of each individual one of the plurality of light sources or a group of the plurality of light sources.

5. The illumination apparatus of claim 4,
wherein each of the plurality of light sources can be controllable by a control device of the illumination apparatus with in each case individual modulation, and an analysis device of the illumination apparatus is designed to obtain, from the signal of the sensor, information relating to a function of each individual one of the plurality of light sources or a group of the plurality of light sources for the control device.

6. The illumination apparatus of claim 2,
wherein each mirror in the mirror device is individually controllable into the second pivot state.

7. The illumination apparatus of claim 6,
wherein one or more of the mirrors for checking the function of the illumination apparatus are movable into the second pivot state cyclically or according to a specified pattern.

8. The illumination apparatus of claim 6,
wherein a plurality of mirrors of the micromirror arrangement form a pattern, and the mirror device is configured such that all the mirrors of the pattern are controllable into the second pivot state at the same time independently of the remaining mirrors of the micromirror arrangement.

9. The illumination apparatus of claim 1,
wherein an optical output, a color point of the light or a wavelength distribution are capturable with the sensor.

10. The illumination apparatus of claim 2,
wherein one or more of the mirrors are controllable into the second pivot state permanently or in specific intervals by the mirror device in dependence on a signal of the sensor.

11. The illumination apparatus of claim 1,
wherein the pivotable mirror is configured for directing light from the one or more light sources in a third pivot state into a third solid angle region located between the first and second solid angle regions, wherein the third pivot state is always adopted if the mirror device is in an unpowered state.

12. The illumination apparatus of claim 1,
wherein the illumination apparatus has at least one LARP light source.

13. A vehicle headlight, comprising:
an illumination apparatus, comprising:
a light-emitting device including one or more light sources,
a mirror device including at least one pivotable mirror for directing light from the one or more light sources in
a defined first pivot state into a first solid angle region in which the light is utilized in accordance with operation, and
a defined second pivot state into a second solid angle range that differs from the first one and in which the light is directed onto an absorber device of the illumination apparatus,
wherein the absorber device comprises a sensor with which a function of the illumination apparatus may be checked.

14. A method for checking a function of an illumination apparatus having one or more light sources, a mirror device including a pivotable mirror for directing light from the one or more light sources in a defined first pivot state into a first solid angle region in which the light is utilized in accordance with operation, and a defined second pivot state into a second solid angle range that differs from the first one and in which the light is directed onto an absorber device of the illumination apparatus,
the method comprising:
checking the function of the illumination apparatus in the second pivot state of the mirror by a sensor of the absorber device.
